(19) United States
(12) Patent Application Publication
(10) Pub. No.: US 2007/0165917 A1
(43) Pub. Date: Jul. 19, 2007

(54) Fully automatic vessel tree segmentation

(76) Inventors: Zhujiang Cao, Hopkins, MN (US); Marek Brejl, Eden Praire, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/287,162

(22) Filed: Nov. 26, 2005

(51) Int. Cl. G06K 9/00

(52) U.S. Cl. 382/128

(57) ABSTRACT

A system including a memory to store image data corresponding to a three dimensional (3D) reconstructed image, and a processor that includes an automatic vessel tree extraction module. The automatic vessel tree extraction module includes a load data module to access the stored image data, a component identification module to identify those components of the image data deemed likely to belong to a vessel, a characteristic path computation module to compute one or more characteristic paths for an identified component having a volume greater than a specified threshold volume value and discard an identified component having a volume less than the specified threshold volume value, and a connection module to connect the computed one or more characteristic paths of the identified component to a characteristic path of another identified component or to a common vessel source until the identified components are connected or discarded.

### TECHNICAL FIELD

The field generally relates to image processing and, in particular but not by way of limitation, to systems and methods for automatically extracting a vessel tree from image data without requiring a user seed input.

### BACKGROUND

Computed X-ray tomography (CT) is a 3D viewing technique for the diagnosis of internal diseases. FIG. 1 shows an example of a prior art CT system 100. The system includes an X-ray source 105 and an array of X-ray detectors 110. In CT, the X-Ray source 105 is rotated around a subject 115 by a CT scanner. The X-ray source 105 projects radiation through the subject 115 onto the detectors 110 to collect projection data. A contrast agent may be introduced into the blood of the subject 115 to enhance the acquired images. The subject 115 may be placed on a movable platform 120 that is manipulated by a motor 125 and computing equipment 130. This allows the different images to be taken at different locations. The collected projection data is then transferred to the computing equipment 130. A 3D image is then reconstructed mathematically from the rotational X-ray projection data using tomographic reconstruction. The 3D image can then be viewed on the video display 135.

Magnetic Resonance Imaging (MRI) is a diagnostic 3D viewing technique where the subject is placed in a powerful uniform magnetic field. In order to image different sections of the subject, three orthogonal magnetic gradients are applied in this uniform magnetic field. Radio frequency (RF) pulses are applied to a specific section to cause hydrogen atoms in the section to absorb the RF energy and begin resonating. The location of these sections is determined by the strength of the different gradients and the frequency of the RF pulse. After the RF pulse has been delivered, the hydrogen atoms stop resonating, release the absorbed energy, and become realigned to the uniform magnetic field. The released energy can be detected as an RF pulse. Because the detected RF pulse signal depends on specific properties of tissue in a section, MRI is able to measure and reconstruct a 3D image of the subject. This 3D image or volume consists of volume elements, or voxels.

Image segmentation refers to extracting data pertaining to one or more meaningful structures or regions of interest (i.e., “segmented data”) from imaging data that includes other data that does not pertain to such one or more structures or regions of interest (i.e., “non-segmented data.”) As an illustrative example, a cardiologist may be interested in viewing 3D images only including segmented data pertaining to the coronary vessel tree. However, the raw image data typically includes coronary vessels along with the nearby heart and other thoracic tissue, bone structures, etc. Image segmentation can be used to provide enhanced visualization and quantification for better diagnosis. The present inventors have recognized a need in the art for improvements in 3D data segmentation and display, such as to improve speed, accuracy, and/or ease of use for diagnostic or other purposes.

### SUMMARY

This document discusses, among other things, systems and methods for automatically extracting a vessel tree from image data without requiring a user seed input. A system example includes a memory to store image data corresponding to a three dimensional (3D) reconstructed image, and a processor that includes an automatic vessel tree extraction module. The automatic vessel tree extraction module includes a load data module to access the stored image data, a component identification module to identify those components of the image data deemed likely to belong to a vessel, a characteristic path computation module to compute one or more characteristic paths for an identified component having a volume greater than a specified threshold volume value and to discard an identified component having a volume less than the specified threshold volume value, and a connection module to connect the computed one or more characteristic paths of the identified component to a characteristic path of another identified component or to a common vessel source until the identified components are connected or discarded.

A method example includes accessing stored image data corresponding to a three dimensional (3D) reconstructed image, identifying components of the image data deemed likely to belong to a vessel, computing one or more characteristic paths for one or more identified components, and for the identified component, forming a vessel tree by connecting the computed one or more characteristic paths of the identified component to a characteristic path of another identified component or to a common vessel source.

This summary is intended to provide an overview of the subject matter of the present patent application. It is not intended to provide an exclusive or exhaustive explanation of the invention. The detailed description is included to provide further information about the subject matter of the present patent application.

### BRIEF DESCRIPTION OF THE DRAWINGS

FIG. 1 is an illustration of an example of a computer tomography (CT) system.

FIG. 2 shows a block diagram of an example of a method of automatically extracting a vessel tree from image data without requiring a user seed input.

FIG. 3 shows an example of an image corresponding to voxels within a bounding box volume formed to include a coronary vessel tree.

FIG. 4 shows an example of an image resulting from retaining structures from FIG. 3 that are likely to be vessels and after a morphology manipulation is performed.

FIGS. 5A-B are simplified illustrations of a two-dimensional (2D) cross-section of a tubular structure.

FIG. 6 is an example image showing the result of removing voxels less likely to correspond to a vessel from the image in FIG. 4.

FIGS. 7A-C are additional simplified illustrations of a two-dimensional (2D) cross-section of a tubular structure.

FIG. 8 shows an example image of an extracted vessel tree.

FIG. 9 shows an example image of the corresponding characteristic paths of the vessel tree of FIG. 8.

FIG. 10 is a block diagram of portions of an example of a system to automatically extract a vessel tree without requiring any user input.

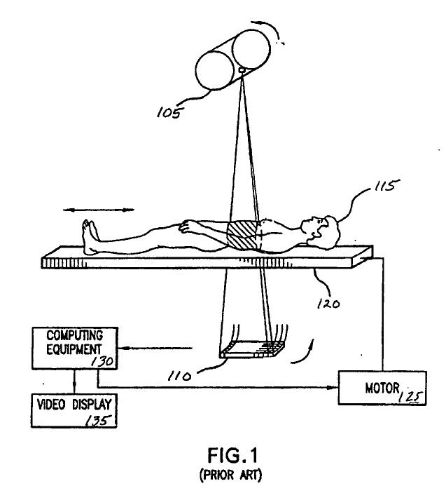

### DETAILED DESCRIPTION

In the following detailed description, reference is made to the accompanying drawings which form a part hereof, and specific examples in which the invention may be practiced are shown by way of illustration. It is to be understood that other embodiments may be used and structural or logical changes may be made without departing from the scope of the present invention.

The functions or methods described herein may be implemented in software. The software comprises computer executable instructions stored on computer readable media such as memory or other type of storage devices. The term “computer readable media” is also used to represent carrier waves on which the software is transmitted. Further, such functions typically correspond to modules, which can be software, hardware, firmware or any combination thereof Multiple functions can be performed in one or more modules as desired, and the embodiments described are merely examples. The software is typically executed on a processor operating on a computer system, such as a personal computer, workstation, server or other computer system.

This document discusses, among other things, systems and methods for automatically extracting a vessel tree from image data without requiring a user seed input. The systems and methods are described in terms of extracting image segments from image data obtained using computed X-ray tomography (CT) images, but the methods and systems described herein also can be used to extract image segments from image data created by other means, such as MRI.

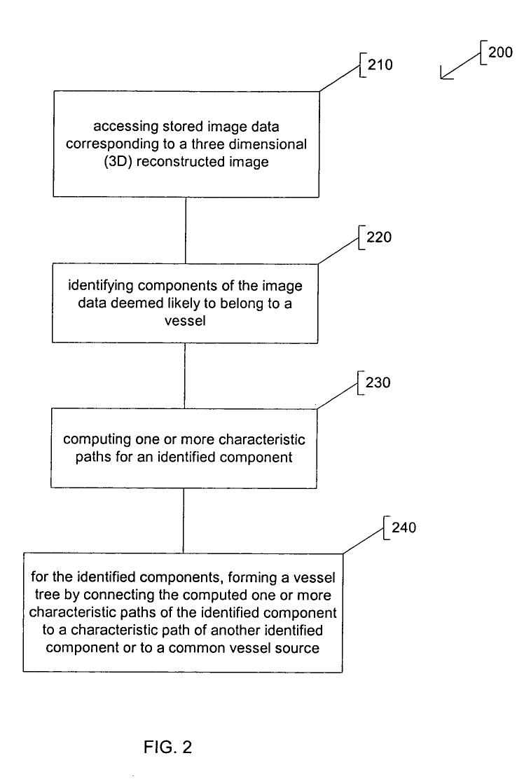

A CT imaging system typically collects a series of axial images from a subject. The axial images are reconstructed into a three-dimensional (3D) image volume of the subject. FIG. 2 shows a block diagram of an example of a method 200 of automatically extracting a vessel tree from image data without requiring any user input beyond specifying what data is desired, for example, avoiding any need for a user-specified seed input to specify a location of a desired vessel.

Upon loading an image volume, the image data is pre-processed through a series of manipulations. The manipulations automatically identify (without needing any user input) those voxels that correspond to components in the image that are more likely to be blood vessels, and then automatically interconnect the components to form a vessel tree, such as a coronary vessel tree. This is in contrast to a segmentation that is only created after a user provides a starting point in the image data from which to begin a segmentation, such as by the user first clicking a mouse at a location in 3D volume where the user deems a coronary vessel to exist, so that the vessel tree including that location can be segmented and displayed. Such a technique can be referred to as a “one click” method. A user typically is required to repeatedly click the mouse at different desired locations to generate diagnostic views of different coronary vessels that include such locations. By contrast, the examples described herein provide, among other things, a computer implemented method that is capable of automatically locating and segmenting the image data corresponding to a coronary vessel tree—without requiring any such user “seed” input. Such a technique can be referred to as a “no click” method.

At 210 in FIG. 2, stored image data corresponding to a three dimensional (3D) reconstructed image is accessed. In some examples, the image data is sub-sampled data, i.e. data that is sampled at less than full resolution of the CT system. Sub-sampled image data can be searched more quickly to find meaningful structures than searching full resolution image data. Typically, the sub-sampled data is a fraction of the highest resolution data. In some examples, the image data is one-half of the highest resolution available. The highest resolution of image data acquired by a CT system is sometimes referred to as RR1 data. Sub-sampled image data at one-half the resolution of RR1 is sometimes referred to as RR2 data. In some examples, the sub-sampled image data is one-fourth of the resolution of the RR1 data, which is sometimes referred to as RR4 data. In some examples, the stored image data includes a combination of high resolution and lower resolution data. In some examples, the stored image data includes three full sets of image data; corresponding to each of the three resolutions, RR1, RR2, and RR4. Other variations are also possible.

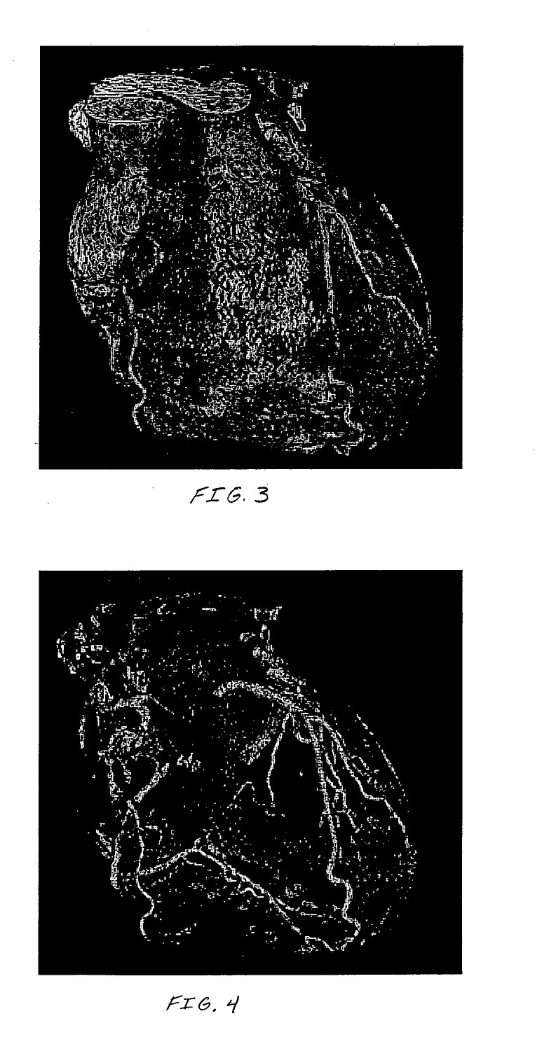

At 220, one or more components or structures of the image data are automatically identified as likely belonging to a vessel. In some examples, identifying such vessel components includes forming a bounding box volume that is likely to include a desired vessel tree of interest. The bounding box is typically a subset of the total scan volume and it is typically used for pre-processing the image data. As an illustrative example, if the vessel tree of interest is a coronary vessel tree, the bounding box can be formed by first accessing an existing heart segmentation of the image data. A heart segmentation is extracted image data pertaining to the heart. The accessed heart segmentation is then dilated by a number of voxels (such as by a layer of three additional voxels beyond the original heart segmentation, for example). This dilation ensures that the coronary vessels are included in the dilated heart segmentation volume. FIG. 3 shows an example of an image corresponding to voxels within a bounding box formed to include the coronary vessel tree.

In some examples, the voxels of the image in the bounding box are separated into foreground voxels and background voxels. A foreground voxel is identified as any voxel within the bounding box volume having a voxel intensity that exceeds (or equals or exceeds) a locally calculated voxel intensity threshold value. A first volume mask is formed from the foreground voxels. A background voxel is identified as any voxel within the bounding box volume having a voxel intensity that is less than the locally calculated voxel intensity value.

Because the image or images within the bounding box are not homogenous, in some examples, the bounding box is divided into sub-regions and the voxel intensity threshold value is calculated locally for each sub-region. In an illustrative example, the bounding box volume is divided into sub-regions of 5 voxel×5 voxel×5 voxel cubes of voxels. An Otsu algorithm is typically used to separate the voxels for a region or sub-region into foreground voxels and background voxels. The Otsu algorithm constructs a histogram of voxel intensity values. The goal is to create a histogram that is substantially bimodal. The higher intensity values are used to calculate the local threshold value. Voxels having an intensity below that threshold value are excluded from the first volume mask. Voxels having an intensity above the threshold value are included in the first volume mask.

In some examples, a histogram is created using constrained data. The data is constrained to exclude voxels that correspond to non-tubular “blob-like” structure(s). Examples of systems and methods of identifying “blob-like” structures in image data are described found in commonly-assigned co-pending Krishnamoorthy et al. U.S. patent application Ser. No. 10/723,445 (Attorney-Docket No. 543.011US1), entitled “SYSTEM AND METHODS FOR SEGMENTING AND DISPLAYING TUBULAR VESSELS IN VOLUMETRIC IMAGING DATA,” which was filed on Nov. 26, 2003, and which is incorporated herein by reference in its entirety, including its description of using constrained data, such as to exclude voxels that correspond to non-tubular “blob-like” structures. Voxels so identified as corresponding to non-tubular “blob-like” structures are not used to create the histogram. In certain examples, the data is further constrained to include only voxels with intensity values within a specified range of values. This is partially because, if a contrast agent is used, structures such as heart chambers (blobs) will have high intensity values that will tend to swamp out the coronary vessels of interest. If a region or sub-region only consists of blob-like structures, the Otsu algorithm histogram will have a single modality, or only one class of voxels. In this case, the Otsu threshold value for the (sub)region can be set equal to −1 Hounsfield units (HU) to identify the region or sub-region as having a single mode.

It may be the case that voxels of a region or sub-region are isotropic. Once a threshold value to separate voxels into foreground and background voxels is calculated, the average intensity and standard deviation of intensity for the foreground voxels, m_{blood,} σ_{blood,} respectively, are calculated as well as the average intensity and standard deviation of intensity for the whole histogram of voxels, m_{whole,} σ_{whole.} The standard deviation of intensity for the whole histogram σ_{whole} is compared to a standard deviation of intensity calculated for a segmentation of the aorta σₐₒᵣₜₐ. In some examples, the aorta segmentation is automatically generated without an input from a user, such as described in commonly-assigned co-pending Samuel W. Peterson et. al. U.S. patent application Ser. No. ______ (Attorney Docket Number 543.03 1US1), entitled AUTOMATIC AORTIC DETECTION AND SEGMENTATION IN THREE-DIMENSIONAL IMAGE DATA, which was filed on Nov. 23, 2005, and which is incorporated herein by reference in its entirety, including its description of automatically generating an aortic segmentation without requiring a user input. If σ_{whole}>σₐₒᵣₜₐ, then the calculated Otsu threshold value is used for the region or sub-region, and m_{blood}, σ_{blood}, are saved for the (sub)region. If σ_{whole}<σₐₒᵣₜₐ, then the (sub)region is determined to have only one class of voxels and m_{whole}, σ_{whole} are used for the (sub)region instead, in which case the corresponding threshold value is m_{whole}−σ_{whole}.

In either case, the resulting threshold value is compared to a minimum threshold value. The larger of the resulting threshold value and the minimum threshold value is used as the local voxel intensity threshold value. Voxels that are below the local voxel intensity threshold value are discarded, and voxels above that threshold value are included in the first volume mask. If the threshold value for a sub-region is −1HU, indicating that the sub-region is unimodal, the whole sub-region is included in the first volume mask.

In certain examples, an average standard deviation is calculated for the first volume mask by

$${σ}_{average} = \frac{{\sum }_{i = 0}^{n} {σ}_{blood}}{n + 1} , \qquad ( 1 )$$

for the n+1 sub-regions numbered 0 to n. If no valid σ_{blood} was found, σₐₒᵣₜₐ is used instead.

In certain examples, one or more morphology manipulations are performed to fill holes in structures and to exclude structures that are less likely to be vessels. In some examples, the first volume mask is used to generate a second volume mask in which to perform the morphology manipulation. The second volume mask is typically generated from a logical AND of the first volume mask with the bounding box volume. This removes non-vessel structures from the bounding box volume. Holes are filled in structures remaining in the second volume mask, such as by dilating the structures and then eroding the resulting structures back toward their original size. In some examples, two cycles of dilating and eroding are performed, such as a first cycle in the XY directions and a second cycle in the Z direction, or vice-versa. This is particularly useful if a voxel size is not uniform in all three directions. The erosion in the Z direction is typically performed using a kernel that is two times the thickness of an image slice.

Structures that are less likely to be vessels are then removed, such as by removing all remaining voxels having an intensity value less than a specified value (e.g., −24 HU). In certain examples, the structures to be removed, such as “blob-like” structures, are identified by eroding within the second volume mask using a kernel size of one-half of the maximum diameter of any blood vessels of interest. As an illustrative example, if the vessels of interest are coronary vessels, a kernel size of seven millimeters (mm) can be used. The remaining eroded structures are then dilated back toward their original size and excluded from the second volume mask.

FIG. 4 shows an example of an image that is the result of identifying and retaining structures in FIG. 3 that are likely to be vessels after performing the threshold calculations and the morphology manipulation described above.

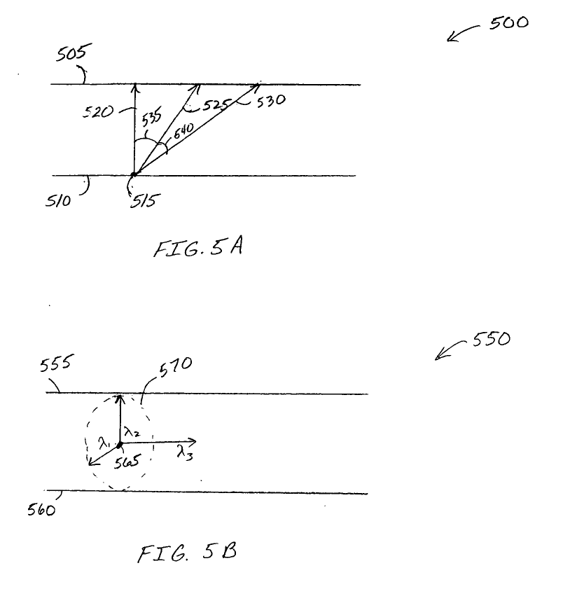

In certain examples, the method further includes calculating a vessel characteristic measure for every voxel in the second volume mask, and excluding from the mask voxels having a vessel characteristic measure less than a specified threshold vessel characteristic value. In some examples, the vessel characteristic measure uses a ray casting scheme. In ray casting, rays are projected outward from the voxel being measured. This is illustrated in FIG. 5A. Assume FIG. 5A illustrates a two-dimensional (2D) cross-section of a tubular structure 500 having walls 505 and 510 and the vessel characteristic measure for the indicated voxel 515 is being calculated. Rays 520, 525, 530 are projected outward from voxel 515. Although a 2D diagram is used for illustrative clarity, it should be noted that the actual ray-casting analysis is done in 3D. To maintain uniform sampling (e.g., equally spaced along the wall 505), the change in rotation angles 535, 540 between rays is changed adaptively. If the same rotation angle is used between rays the distance between termination points of the rays would vary greatly. To provide uniform sampling, the subsequent ray's rotation angle is set to a value inversely proportional to the traveling distance of the previous ray. Thus, rotational angle 540 is inversely proportional to the length of ray 525.

When a ray is projected outward, it is stopped at least when one of three events occurs: a) when it travels outside the second volume mask, b) when it travels longer than a predefined distance, or c) when the ray encounters a voxel having an intensity value less than the intensity of the source voxel minus two times the average standard deviation σ_{average} calculated in equation (1). In FIG. 5A, if the tubular structure 500 is a vessel containing blood and contrast agent, a ray 520, 525, or 530 will stop after it passes the vessel wall 505. The termination points of such rays are then recorded. The termination points of the rays are used as inputs for a feature analysis, such as Principal Component Analysis (PCA). FIG. 5B shows a two-dimensional (2D) cross-section of a tubular structure 550 having walls 555 and 560. The feature analysis finds the orthogonal orientation of voxel 565. The feature analysis finds the eigenvectors and eigenvalues for the structure at the voxel 565.

The eigenvectors are three mutually orthogonal axes. In FIG. 5B two of the eigenvectors lie in a plane of a cross-section 570 of the tubular structure 550 and the third is perpendicular to the cross-section 570. The eigenvalues λ₁, λ₂ and λ₃ are related to the distances to the boundary of the structure from the voxel 565 along the three axes and the known dimensions of the vessels of interest. If λ₁=λ₂, then the cross-section is a circle. The second eigenvalue λ₂ is related to the radius of the structure. The eigenvalues are oriented so that typically λ₁<λ₂<λ₃. If λ₁ and λ₂ are less than a specified eigenvalue or eigenvalues, the voxel 565 being measured is deemed to be not part of any vessel. As an illustrative example, if the vessel of interest is a coronary vessel, then if λ₂<0.1 or λ₁<0.05, then the voxel 565 is deemed to not belong to a coronary vessel. If λ₁, λ₂ are of the proper size, then the vessel characteristic measure ν is

$$v = {ⅇ}^{\frac{1}{3} ( \frac{{λ}_{3}}{{λ}_{2}} - \frac{{λ}_{2}}{{λ}_{1}} )} , for {λ}_{2} \leq 4 , and \\ v = {ⅇ}^{\frac{1}{3} ( \frac{{λ}_{3}}{{λ}_{2}} - \frac{{λ}_{2}}{{λ}_{1}} - {λ}_{2} )} , for {λ}_{2} > 4. \qquad ( 2 )$$

If λ₃/λ₂ is a large number, the vector orthogonal to the cross-section is long which leads to a high vessel characteristic measure ν. If λ₂/λ₁ is too large, then the cross-section of the structure is less likely to be circular and less likely to be a vessel. Thus, in equation (4), λ₂/λ₁ and λ₂ are used to reduce the contribution of λ₃/λ₂ to the vessel characteristic measure.

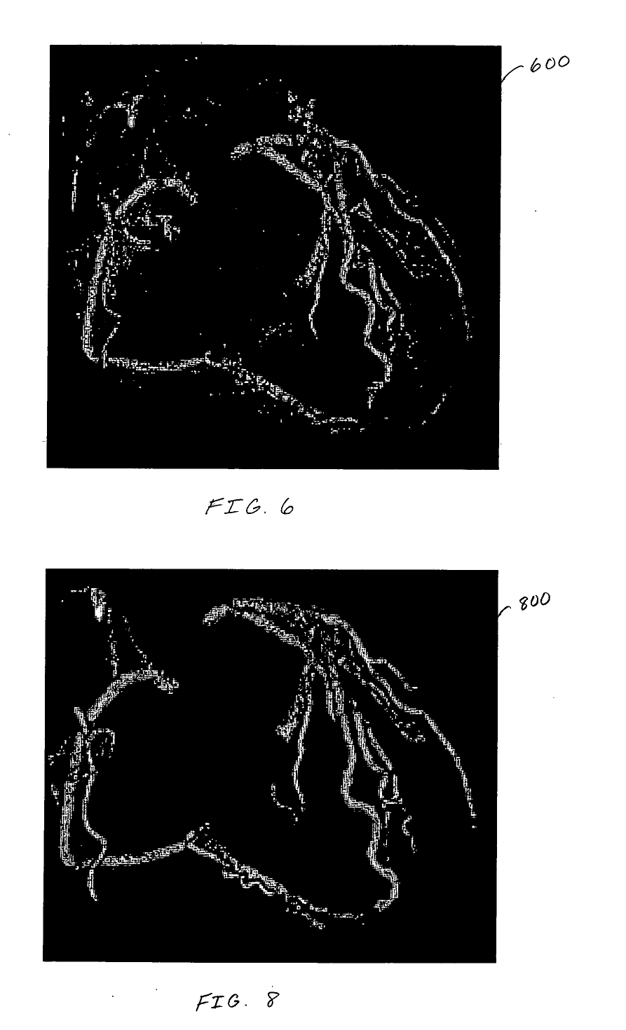

As discussed previously, if the calculated vessel characteristic measure ν for the voxel is less than a specified threshold vessel characteristic value, then the voxel is discarded from the second volume mask. Otherwise, the voxel is retained. FIG. 6 is an example image 600 that shows the result of removing voxels having a vessel characteristic measure ν that is less than a specified vessel characteristic threshold value from the image in FIG. 4.

Returning to the method 200 of FIG. 2, at 230 one or more characteristic paths are computed for the components that have been identified. In some embodiments, the characteristic path is computed only for those components having a volume that is greater than a specified threshold volume value; components less than the specified threshold volume value are discarded. In some examples, to determine if an identified component has sufficient volume, the second volume mask is calculated, such as described above. One or more regions of the second volume mask are then grown to locate isolated components inside the second volume mask. The resulting located components are then ordered according to their size or volume, i.e. according to the number of voxels they include. Components having a size less than the specified threshold volume value are discarded.

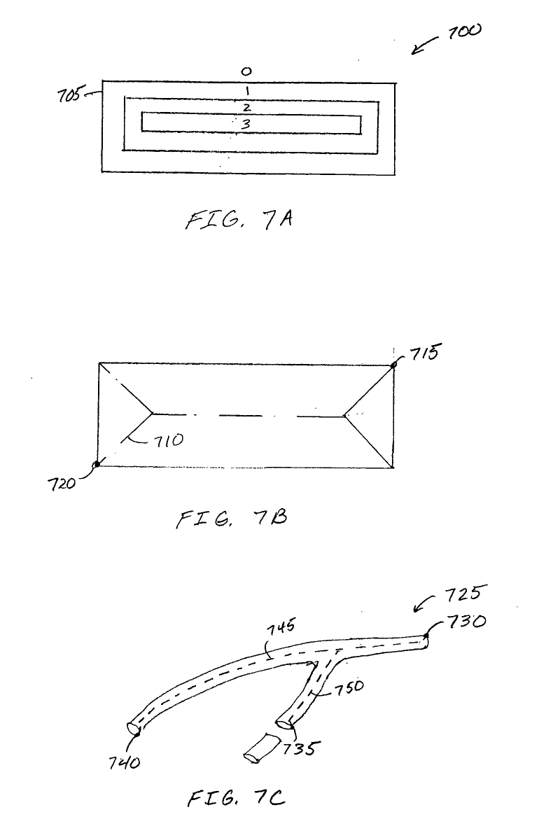

In some examples, computing one or more characteristic paths for an identified component includes constructing a “skeleton” for the identified component. One way to compute the skeleton of an object is by distance mapping. Other methods to obtain a skeleton of an object include calculating Voronoi diagrams and iterative thinning of the object. In distance mapping, each voxel is assigned a value corresponding to the shortest distance to the boundary of the component. FIG. 7A illustrates an example of a 2D cross-section of a simple tubular structure 700. The structure 700 is five voxels wide and the distance to a location outside the boundary 705 of the structure 700 is shown. To find the skeleton, the gradient of the distance map is calculated and the voxels with the gradient values less than a specified threshold value are identified as the skeleton. FIG. 7B illustrates the resulting skeleton 710 of the exemplary structure 700.

The skeleton includes a root point and one or more end points. The root point is chosen to be the point closest to the common vessel source. An end point is chosen to be a point farthest away from the root point. In FIG. 7B, if the common vessel source is to the upper right of the diagram, then the root point 715 is to the upper right and the endpoint 720 is to the lower left. In certain examples, the root point is chosen as the point having the shortest Euclidian distance to the common vessel source and an end point is chosen as the point having the longest geodesic distance to the root point inside the identified component. FIG. 7B shows a relatively simple structure, for providing conceptual clarity. However, structures that are more physiologic in shape may include more than one endpoint. FIG. 7C is an illustration of a branching vessel-like structure 725 having a root point 730 and more than one endpoint 735, 740. The characteristic path for a component is then calculated between the root point and a first end point (typically endpoint 740) according to a cost function. In some examples, the cost function is the inverse of the distance map of the component, and points of the skeleton are assigned a lowest cost. The characteristic path is a lowest cost path between the root point and the endpoint. FIG. 7C shows an example of a characteristic path 745 from the root point 730 to a first endpoint 740.

Once a characteristic path of an identified component is found, the characteristic path is dilated to extract a first branch of the component. The skeleton is removed from inside the first branch. If the identified component has more than one end point, a second endpoint is located and a characteristic path is calculated between the root point and the second end point according to the cost function. FIG. 7C shows an example of a characteristic path 750 from the root point 730 to a second endpoint 735. The second characteristic path 750 is dilated to extract a second branch of the component. The skeleton is removed from inside the second branch. If the identified component includes more branches, the process of calculating the characteristic paths and dilating the characteristic paths to remove the skeletons is continued until all skeleton points are removed from the component.

Returning to the method 200 of FIG. 2, at 240 a vessel tree is formed using the identified components by connecting the computed one or more characteristic paths of the identified component to a characteristic path of another identified component or to a common vessel source. In some examples, a bounding box volume is formed to define a volume that is more likely to include the vessel tree, and the identified components are within the bounding box volume. In some examples, a second volume mask is formed and manipulated by any of the methods described previously to identify the components.

One task is to connect characteristic paths from all the identified components together and connect them back to the common vessel source. At the same time, components that have been identified but are not part of the vessel tree, which can be thought of as “false positives,” should be discarded. One way to do this is to impose connection constraints on the process.

In some examples, a cost map is calculated for the voxels included in the bounding box volume. To build the cost map, voxels included in a characteristic path within the volume are given the lowest cost. Voxels within the second volume mask are given a cost calculated by
Cost=α·(MaxCost)−β·(Gray Value)−γ·(vessel). (3)
MaxCost is an assigned maximum cost value, GrayValue is the gray value intensity of the voxel (which, in turn, corresponds to a density, in a CT example), and vessel is the value of the characteristic vessel measure of the voxels in the second volume mask. The parameters α, β, and γ are weights assigned to the values. For voxels inside the bounding box volume but outside the second volume mask, if the voxels are foreground voxels the cost of the voxels is calculated by
Cost=α·(MaxCost)−β·(GrayValue). (4)
If the voxels are within the bounding box volume, but are not foreground voxels, the cost is
Cost=α·(MaxCost). (5)
A goal is to connect the characteristic paths through the highest intensity voxel values. Thus, the connection should give priority to first connecting the voxels of the characteristic path and then the voxels with a high intensity value and a high possibility that they belong to vessels.

After the cost map is built, a cost is calculated for a path from the root point of each identified component's characteristic path to the common vessel source. The root point of a characteristic path can have multiple destination points; either to the common source directly or to characteristic paths of other identified components. One approach of determining the connection would be to determine the possible paths to all destination points separately and then to compare the cost of each path afterwards. Another approach is to specify the possible destination points, but once a destination is reached, the connecting process is completed without finding other paths. The result is connecting the lowest cost path between the root point and the possible destination points.

In some examples, once the lowest cost path is found, a connection possibility score for the path is calculated. In some examples, the connection possibility score includes an average vessel characteristic measure of voxels included in the path. If the vessel characteristic measure was calculated previously (e.g. because the voxel is included in the second volume mask) that measure is used. If the vessel characteristic measure for a voxel was not calculated before, it is calculated during this scoring process. In some examples, the vessel characteristic measure is clamped to range of values to prevent large values of the vessel characteristic measure from skewing the results.

In some examples, to identify paths including false positives, one or more connection constraints are imposed. In a constraint example, the lowest cost path found is declared to be a valid path if the number of voxels of the identified component being connected is greater than a specified threshold number of voxels and the connection possibility score is greater than a first specified threshold score value, which is typically a relatively large score value. Thus, components that are large and have a high possibility of being a vessel are unlikely to be false positives and are retained.

In some cases, the process will try to form a path that includes a relatively small component. The component is retained if it has a high possibility of being a vessel. Thus, in another constraint example, the path is declared to be a valid path if the number of voxels of an identified component being connected is less than the specified threshold number, the lowest cost path does not connect the root point to the common vessel source, but the connection possibility score is greater than the first specified threshold score value.

In some cases, the process will try to form a path that includes a relatively small component and has a lower score. However, the position of the component in relation to the common vessel source makes it a good candidate for being part of a valid path. Thus in another constraint example, the lowest cost path is declared a valid path if the number of voxels of an identified component is less than a specified threshold number, the root point is located within a specified distance from the common vessel source, the end point is located a specified distance away from the common vessel source, and the connection possibility score is greater than a second specified threshold score value. The second specified threshold score value is less than the first specified threshold score value. In some examples, the second specified threshold score value is one-half the value of the first specified threshold score value.

Once all the identified components are connected into valid paths, a diagnostic 3D image is formed representing the vessel tree. The diagnostic image can then be displayed on a two-dimensional (2D) screen. In some examples, the diagnostic image is displayed at a reviewing workstation in an interactive environment. In some examples, the image is saved and stored for future viewing in a static mode. The image can be saved in memory on a workstation or saved in a server on a network and accessed over the network.

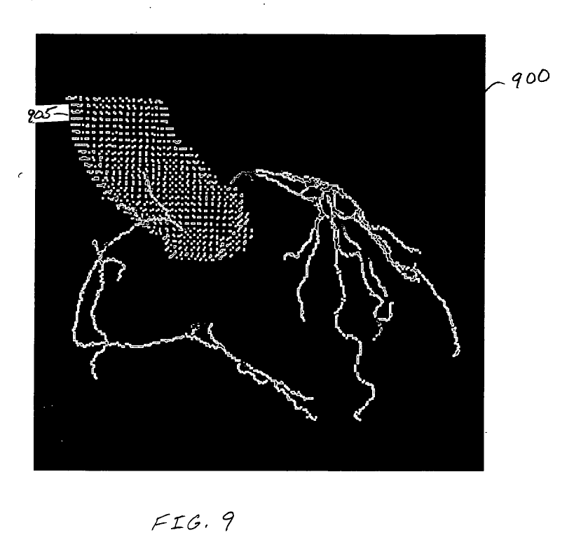

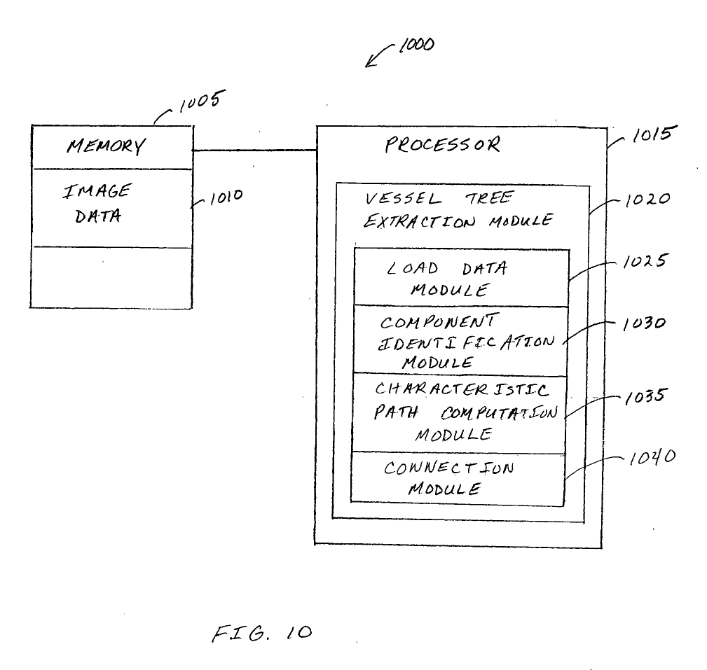

FIG. 8 shows an example image 800 of a vessel tree. The example shown is of a coronary vessel tree. For the coronary vessel tree, the common vessel source is a segmentation of the aorta, which can be obtained as described above. FIG. 9 shows an example image 900 of the corresponding characteristic paths of the vessel tree and their position related to the aorta segmentation 905. Images of other vessel trees can also be created with the methods and systems described herein, and no user-input is required to “seed” generation of the vessel tree.

FIG. 10 is a block diagram of portions of an example of a system 1000 to automatically extract a vessel tree without requiring any user input, such as a user-specified seed location. In this example, the system 1000 includes a memory 1005 to store image data 1010 and a processor 1015. The image data 1010 is used to reconstruct a 3D image. In some examples, the image data 1005 includes sub-sampled data, such as discussed above. In some examples, the image data 1005 includes a heart segmentation, such as discussed above. The processor 1015 is in communication with the memory 1005, such as by communicating over a network or by the memory 1005 being included in the processor 1015. In some examples, the system 1000 includes a server having a server memory, and the memory 1005 storing the image data 1010 is included in the server memory. In such examples, the processor 1015 typically accesses the image data 1010 from the server over the network. The processor 1015 includes performable instructions that implement an automatic vessel tree extraction module 1020, which, in turn, includes a load data module 1025 to access the stored image data 1010, a component identification module 1030, a characteristic path computation module 1035, and a connection module 1040.

The component identification module 1030 identifies those components of the image data that are deemed likely to belong to a vessel, such as by using any of the methods described previously. In some examples, the component identification module 1030 includes a volume mask generating module to generate the bounding box volume, or the first volume mask, or the second volume mask, or combinations including the volumes and masks as described herein. In some examples, the volume mask generating module includes a sub-division module to divide a volume mask into sub-regions and a threshold module to calculate a local voxel intensity threshold value, such as described above. The local voxel intensity threshold value is then used to separate voxels into foreground voxels and background voxels, such as described above. In some examples, the volume mask generating module includes a morphology module to perform one or more morphology manipulations on structures in the volumes or masks, such as described above.

In some examples, the component identification module 1030 includes a vessel characteristic calculation module to calculate a vessel characteristic measure, which indicates a likelihood that a voxel in the image data belongs to a vessel image.

The characteristic path computation module 1035 computes one or more characteristic paths for an identified component having a volume greater than a specified threshold volume value and discards an identified component having a volume less than the specified threshold volume value. In some examples, the characteristic path computation module 1035 includes a pruning module to locate isolated components and discard any isolated components that have a volume less than the specified threshold volume value. In some examples, the characteristic path computation module 1035 includes a skeleton construction module to construct a skeleton for an identified component and a point location module to locate a root point and one or more end points. The characteristic path computation module 1035 assigns a cost to points of the skeleton and calculates a characteristic path between the root point and an end point according to a cost function.

In some examples, the characteristic path computation module 1035 includes a dilation module. The dilation module dilates a computed characteristic path of an identified component to extract a branch of the identified component and to remove the skeleton from the branch. The characteristic path computation module iteratively calculates characteristic paths, extracts the branch, and removes the skeleton from the branch until all skeleton points are removed from the identified component.

The connection module 1040 connects the computed one or more characteristic paths of the identified component to a characteristic path of another identified component or to a common vessel source until any identified components are connected or discarded. In some examples, the connection module 1040 includes a cost map module to map a calculated cost of voxels within a volume such as the bounding box volume and to assign a cost to voxels included in a characteristic path within the volume. The connection module 1040 uses the cost map to calculate a cost of a path from a root point of the characteristic path to one or more possible destination points and to connect the root point to a destination point according to the cost.

In some examples, the connection module 1040 includes a path validation module to identify paths containing false positives. In some examples, the path validation module calculates a connection possibility score for a computed path between the root point and a destination point to impose connection constraints on the computed paths. In some examples, the path validation module uses a vessel characteristic measure in determining the connection possibility score.

In some examples, the processor 1015 includes other automatic segmentation modules, such as an automatic aorta segmentation module. This is useful if it is desired to extract a coronary vessel tree and the common vessel source is the aorta. Another automatic segmentation module is an automatic heart segmentation module. This is useful to form a bounding box volume for a coronary vessel tree. In some examples, the system includes a display to represent at least a portion of the 3D imaging data representing coronary vessels on a 2D screen.

The systems and methods described above improve diagnostic capability by automatically extracting a segmentation of a vessel tree. The segmentation is provided without requiring a user to specify a seed point from which to begin the segmentation. This allows the segmentation to begin upon loading of the data. The user, such as a diagnosing physician, receives the segmentation faster and easier than if the segmentation did not begin until user input is received. This reduces the time required in providing the segmentation and prevents the user from having to wait while the image data is loaded and the segmentation process executes. The systems and methods of vessel tree segmentation discussed herein can be combined with automatic segmentation of other physiologic structures of interest, such as automatic aorta segmentation or automatic heart segmentation.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations, or variations, or combinations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own.

What is claimed is:

1. A method of automatically locating a vessel tree in image data without requiring a user seed input, the method comprising:
accessing stored image data corresponding to a three dimensional (3D) reconstructed image;
identifying components of the image data deemed likely to belong to a vessel;
computing one or more characteristic paths for one or more identified components; and
forming a vessel tree by connecting the computed one or more characteristic paths of the identified component to a characteristic path of another identified component or to a common vessel source.

2. The method of claim 1, wherein identifying components likely to belong to a vessel includes:
forming a bounding box volume likely to include the vessel tree; and
forming a first volume mask of foreground voxels, wherein a foreground voxel is identified as any voxel within the bounding box volume that exceeds a locally calculated voxel intensity threshold value.

3. The method of claim 2, wherein forming the first volume mask further includes:
dividing the first volume mask into sub-regions;
calculating a local voxel intensity threshold in each sub-region and identifying a foreground voxel as any voxel in a sub-region that exceeds the local voxel intensity threshold; and
excluding a voxel from the first volume mask having a voxel intensity less than the locally calculated voxel intensity threshold value.

4. The method of claim 2, further including performing a morphology manipulation within the bounding box volume to fill one or more holes in one or more structures and to exclude one or more structures less likely to be a vessel.

5. The method of claim 4, wherein performing a morphology manipulation includes:
generating a second volume mask in which to perform the morphology manipulation from a logical AND of the first volume mask with the bounding box volume;
dilating one or more structures within the second volume mask to fill one or more holes and eroding the dilated one or more structures toward their original size; and
removing one or more structures less likely to be a vessel.

6. The method of claim 5, wherein removing one or more structures less likely to be a vessel includes eroding one or more structures within the second volume mask with a kernel size of one-half of the maximum diameter of vasculature of interest, dilating one or more remaining eroded structures toward their original size, and excluding the dilated remaining one or more structures from the second volume mask.

7. The method of claim 5, further including:
calculating a vessel characteristic measure for one or more voxels in the second volume mask; and
discarding a voxel having a vessel characteristic measure less than a specified threshold vessel characteristic value.

8. The method of claim 1, wherein computing one or more characteristic paths includes:
computing one or more characteristic paths for an identified component having a volume greater than a specified threshold volume value; and
discarding an identified component having a volume less than the specified threshold volume value.

9. The method of claim 8, wherein computing one or more characteristic paths for an identified component includes:
constructing a skeleton for the component;
locating a root point and one or more end points on the skeleton; and
assigning a lowest cost to points of the skeleton and calculating a characteristic path between the root point and a first end point according to a cost function.

10. The method of claim 9, wherein locating a root point and one or more end points includes:
locating a root point on the skeleton having a shortest Euclidian distance to the common vessel source; and
locating an end point on the skeleton having a longest geodesic distance to the root point inside the identified component.

11. The method of claim 9, including,
dilating the characteristic path to extract a first branch of the identified component;
removing the skeleton inside the first branch;
locating a second endpoint of the component, if any;
calculating a characteristic path between the root point and the second end point using the cost function;
dilating the characteristic path to extract a second branch of the component;
removing the skeleton inside the second branch; and
continuing the calculating and dilating until all skeleton points are removed from the identified component.

12. The method of claim 1, wherein forming a vessel tree includes:
forming a bounding box volume more likely to include a vessel tree;
calculating a cost map for voxels within the bounding box volume, wherein voxels included in a characteristic path within the volume are given the lowest cost;
connecting the characteristic path of an identified component by calculating a lowest cost path from a root point of the characteristic path to one or more possible destination points; and
connecting the root point to a destination point according to a cost of the path.

13. The method of claim 12, wherein the image data includes a segmentation of a heart and wherein forming a first bounding box volume includes dilating the heart segmentation to form a bounding box volume that is more likely to include one or more coronary vessels than are included in the heart segmentation, and wherein the common vessel source includes an aorta segmentation.

14. The method of claim 12, wherein connecting the root point to a destination point includes:
calculating a connection possibility score for the lowest cost path; and
declaring the lowest cost path a valid path if a number of voxels of an identified component is greater than a specified threshold number and the connection possibility score is greater than a first specified threshold value.

15. The method of claim 14, wherein calculating a connection possibility score includes calculating an average vessel characteristic measure of voxels included in the lowest cost path, the vessel characteristic measure indicating a likelihood that the voxel corresponds to a vessel.

16. The method of claim 14, wherein declaring the lowest cost path a valid path includes:
declaring the lowest cost path valid if the number of voxels of an identified component is less than a specified threshold number, the lowest cost path does not connect the root point to the common vessel source, and the connection possibility score is greater than the first specified threshold value; and
declaring the lowest cost path valid if the number of voxels of an identified component is less than a specified threshold number, the root point is located within a specified distance from the common vessel source, the end point is located a specified distance away from the common vessel source, and the connection possibility score is greater than a second specified threshold value.

17. The method of claim 1, wherein forming a vessel tree further includes forming a coronary vessel tree by connecting the computed one or more characteristic paths of the identified component to a characteristic path of another identified component or to an aorta segmentation.

18. The method of claim 17, including automatically detecting the aorta segmentation without requiring a user seed input.

19. The method of claim 1, further including forming a diagnostic 3D image representing the vessel tree and displaying the diagnostic image on a two dimensional (2D) screen.

20. A machine readable medium including machine instructions to perform a method comprising:
accessing stored image data corresponding to a three dimensional (3D) reconstructed image;
identifying one or more components of the image data deemed likely to belong to a vessel;
computing one or more characteristic paths for one or more identified components; and
forming a vessel tree by connecting a characteristic path of an identified component to a characteristic path of another identified component or to a common vessel source.

21. A system comprising:
a first memory to store image data corresponding to a three dimensional (3D) reconstructed image; and
a processor in communication with the first memory, wherein the processor includes an automatic vessel tree extraction module comprising:
a load data module to access the stored image data;
a component identification module to identify those one or more components of the image data deemed likely to belong to a vessel;
a characteristic path computation module to compute one or more characteristic paths for an identified component having a volume greater than a specified threshold volume value and to discard an identified component having a volume less than the specified threshold volume value; and
a connection module to connect the computed one or more characteristic paths of the identified component to a characteristic path of another identified component or to a common vessel source until the identified components are connected or discarded.

22. The system of claim 21, wherein the component identification module includes:
a volume mask generating module to:
form a bounding box volume more likely to include a vessel tree;
calculate a local voxel intensity threshold value; and
generate a first volume mask out of foreground voxels, the foreground voxels identified as any voxel within the bounding box volume that exceeds a locally calculated voxel intensity threshold value; and
generate a second volume mask that excludes structures less likely to be vessels; and
a vessel characteristic calculation module to calculate a vessel characteristic measure indicating a likelihood that a voxel belongs to a vessel image and discard second volume mask voxels having a vessel characteristic measure less than a specified threshold vessel characteristic value.

23. The system of claim 22, wherein the image data includes a heart segmentation, and wherein the volume mask generating module is operable to form a bounding box volume by dilating the heart segmentation to a volume more likely to include additional coronary vessels.

24. The system of claim 22, wherein the volume mask generating module is further includes a sub-division module to divide the first volume mask into sub-regions, and a threshold module to calculate a voxel intensity threshold value by using an Otsu algorithm on a constrained histogram of intensities of voxels within each sub-region.

25. The system of claim 22, wherein the volume mask generating module is further operable to form a second volume mask from a logical AND of the foreground voxels with the bounding box volume; and further includes a morphology module operable to:
dilate any structures within the second volume mask to fill holes, if any, and erode the dilated structures toward their original size;
discard a voxel within the second volume mask having a voxel intensity less than a specified threshold intensity value; and
erode any structures within the second heart mask with a kernel size of one-half of the maximum diameter of a vessel of interest, dilate remaining structures toward their original size, and exclude the remaining structures from the second volume mask.

26. The system of claim 22, wherein the characteristic path computation module includes a pruning module to:
grow one or more regions of the second volume mask to locate isolated components inside the second volume mask; and
discard any isolated components having a volume less than the specified threshold volume value.

27. The system of claim 21, wherein the characteristic path computation module includes:
a skeleton construction module to construct a skeleton for the component; and
a point location module to locate a root point and one or more end points; and wherein the characteristic path computation module assigns a lowest cost to points of the skeleton and calculates a characteristic path between the root point and a first end point according to a cost function.

28. The system of claim 27, wherein the point location module locates a root point on the skeleton having the shortest Euclidean distance to the common source and locates one or more endpoints having the longest geodesic distance to the root point inside the identified component.

29. The system of claim 27, wherein the characteristic path computation module further includes a dilation module to dilate a computed characteristic path of an identified component to extract a branch of the identified component and to remove the skeleton from the branch, and wherein the characteristic path computation module is operable to continue to locate endpoints of additional identified components, if any, calculate characteristic paths between the root point and any end points according to the cost function, and dilate the characteristic paths to extract branches of the identified component until all skeleton points are removed from the identified component.

30. The system of claim 21, wherein the component identification module includes a bounding box module to form a bounding box more likely to include a vessel tree;
wherein the connection module includes a cost map module to map a calculated cost of voxels within the bounding box volume and assign a cost to voxels included in a characteristic path within the volume; and
wherein the connection module connects the characteristic path of an identified component by calculating a cost of a path from a root point of the characteristic path to one or more possible destination points using the cost map and connecting the root point to a destination point using a lowest cost path.

31. The system of claim 21, wherein the connection module is operable to connect the computed one or more characteristic paths of the identified component to a characteristic path of another identified component or to a common vessel source.

32. The system of claim 31, wherein the processor further includes an automatic aortic root detection module.

33. The system of claim 21, wherein the connection module further includes a path validation module to calculate a connection possibility score for a lowest cost path between the root point and a destination point using a vessel characteristic measure, the vessel characteristic measure indicating a likelihood that the voxel corresponds to a vessel; and
to declare the lowest cost path a valid path if a number of voxels of an identified component is greater than a specified threshold number and the connection possibility score is greater than a first specified threshold value.

34. The system of claim 33, wherein the path validation module is operable to declare the lowest cost path a valid path if
the number of voxels of an identified component is less than a specified threshold number, the lowest cost path does not connect the root point to an aorta segmentation, and the connection possibility score is greater than the first specified threshold value, or,
if the number of voxels of an identified component is less than a specified threshold number, the root point located within a specified distance from the common source, the end point located a specified distance away from the common source, and the connection possibility score is greater than a second specified threshold value.

35. The system of claim 21 further including a display to represent at least a portion of the 3D imaging data representing coronary vessels on a two dimensional (2D) screen.

36. The system of claim 21 further including a server in communication with the processor over a network, wherein the server includes a second memory, and wherein the second memory includes the first memory and the load data module loads image data from the server over the network.
